(19) United States
(12) Patent Application Publication
(10) Pub. No.: US 2007/0044822 A1
(43) Pub. Date: Mar. 1, 2007

(54) Car wash and maintenance system

(76) Inventor: Suk Joon Oh, Torrance, CA (US)

Correspondence Address: PARK LAW FIRM, 3255 WILSHIRE BLVD, SUITE 1110, LOS ANGELES, CA, 90010, US

(21) Appl. No.: 11/210,722

(22) Filed: Aug. 24, 2005

(51) Int. Cl. B08B 3/02

(52) U.S. Cl. 134/26; 134/34; 134/32

(57) ABSTRACT

A method for car wash and maintenance includes steps for car-washing, post-washing for preparing the car for the driver's riding, and performing a basic car maintenance. The step of performing a basic car maintenance is performed during the step of post-washing. The step of performing a basic car maintenance also includes steps of coordinating in space and time with the step of post-washing, accessing the car, and maintaining the car. The step of coordinating in space and time with the step of post-washing is performed by providing an extra accessing space for the maintenance work. The extra accessing space is provided by a pit below the car. The basic car maintenance includes oil change process. The maintenance work is coordinated to be performed under the car from the opposite underside where the post-washing work is performed.

### BACKGROUND OF THE INVENTION

The present invention relates to a car wash and maintenance system. More particularly, this invention relates to a car wash and maintenance system in which car wash and maintenance are performed concurrently.

The car is not just another means of transportation in the long line of different kinds such as bicycle, wagon, horse, boat, and airplane to name a few. The car is an indispensable ingredient of the modern life. It expanded the spatial stage of human activity to every corner of the lands and shrank the temporal interval of human activity scattered all around of the surface of the Earth. Without it, we cannot talk about the urban life in metropolitan areas at all. The car has become something more than another set of legs for a modern human being.

The car wash appeared no later than 1914, not long after the advent of the car itself. The convenience and low cost make more people use the car wash, especially the automatic ones.

These days, many kinds of different levels of car washes are provided—cleaning the interior and exterior of the car, and many others, etc. In some cases, it takes longer than 10 minutes, which is long enough to perform some of the car maintenance work. If so, the drivers can make the most of the time required for the car wash, which will be directly related to economic gains.

Accordingly, a need for a car wash and maintenance system has been present for a long time. This invention is directed to solve the related problems and satisfy the long-felt need.

### SUMMARY OF THE INVENTION

The objective of the invention is to provide a car wash and maintenance system, in which the car maintenance work is performed during the car wash.

Another objective of the invention is to provide a car wash and maintenance system, in which the car maintenance work is performed by accessing the car on the opposite underside from where the car wash is being performed.

Still another objective of the invention is to provide a car wash and maintenance system, which saves a lot of time and will be related to the economic gains.

A method for car wash and maintenance includes steps for car-washing, post-washing for preparing the car for the driver's riding, and performing a basic car maintenance. The step of basic car maintenance is performed during the step of post-washing.

The method further includes a step of pre-washing for preparing the car for washing, and the step of pre-washing includes steps for drive-in and latching of the car.

The step of car-washing includes steps for pre-soaking, soaping-up, scrubbing, and rinsing.

The step of post-washing includes a step of drying.

The step of post-washing further includes steps of waxing and touching-up.

The step of performing a basic car maintenance includes steps of coordinating in space and time with the step of post-washing, accessing the car, and maintaining the car. The step of coordinating in space and time with the step of post-washing is performed by providing an extra accessing space for the maintenance work. An extra accessing space is provided by a pit below the car. The pit is about 1 to 2 meters deep.

The basic car maintenance includes oil change process. The maintenance work is performed from under the car, and the post-washing work is performed from above the car. The maintenance work is coordinated to be performed in the opposite underside of the car from the side where the post-washing work is performed. The basic car maintenance further includes car inspection and brake pad change.

A system for car wash and maintenance includes a washing device for cleaning the car, a drying device for drying the car, and a maintaining device comprising an accessing space for the maintenance work. The maintaining device performs the maintenance works in the accessing space while the works of drying and touching-up are going on.

The access space includes a pit below the car. The pit is adapted for the maintenance work to be performed.

The system further includes an entrance for introducing a car into the system, a conveyor device for proceeding the car along the following steps, and a car-latching device for fixing the car on the conveyor device.

The system still further includes a waxing device for coating the car with a protective thin film, a touching-up device, and an exit for exiting the system.

The advantages of the present invention are: (1) the car wash and maintenance method and system provide the driver or customer with saving of time; (2) the car wash and maintenance system can be easily enabled by ingenious manipulating the spatial and temporal line of the car wash and the car maintenance without a terribly high cost; (3) the invention provides a car wash and maintenance system at one location concurrently, which saves a lot of time of the car owner and will be directly related to a big saving in car maintenance to both owner and service provider.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a flow chart showing a flow of works according to the present invention;

FIG. 2 is a plan view of the system according to the present invention;

FIG. 3 is a cross-section view of a car right above a maintenance pit;

FIG. 4 is a plan view of two cars over a pit.

### DETAILED DESCRIPTION OF THE INVENTION

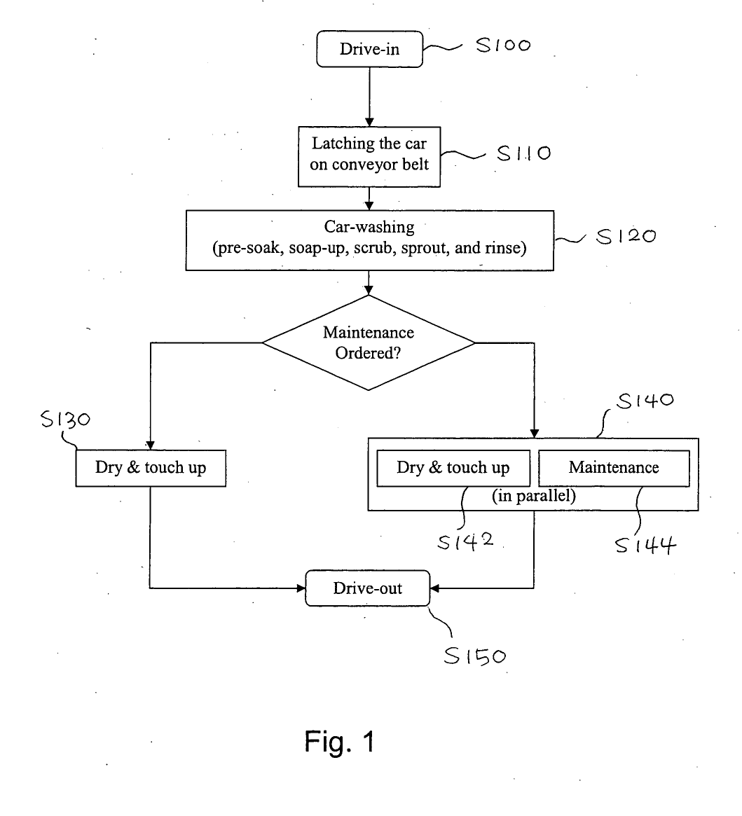

FIG. 1 is a flow chart showing a flow of works according to the present invention.

A method for car wash and maintenance includes steps for car-washing S120, post-washing S130 for preparing the car for the driver's riding, and performing a basic car maintenance S144. The step of performing a basic car maintenance S144 is performed during the step of post-washing S142 is going on as a parallel step S140.

The method further includes a step of pre-washing for preparing the car for washing, and the step of pre-washing includes steps for drive-in S100 and latching the car S110.

The step of car-washing S120 includes steps for pre-soaking, soaping-up, scrubbing, and rinsing.

The step of post-washing S130, S142 includes a step of drying.

The step of post-washing S130, S142 further includes steps of waxing and touching-up.

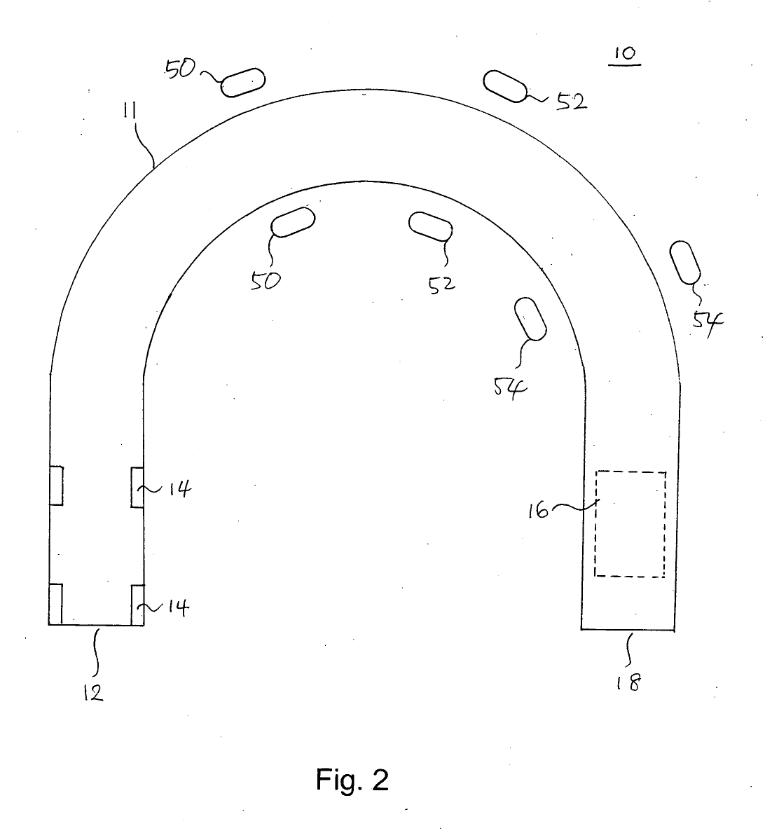

A system 10 with which the method of the present invention is performed is shown in FIG. 2.

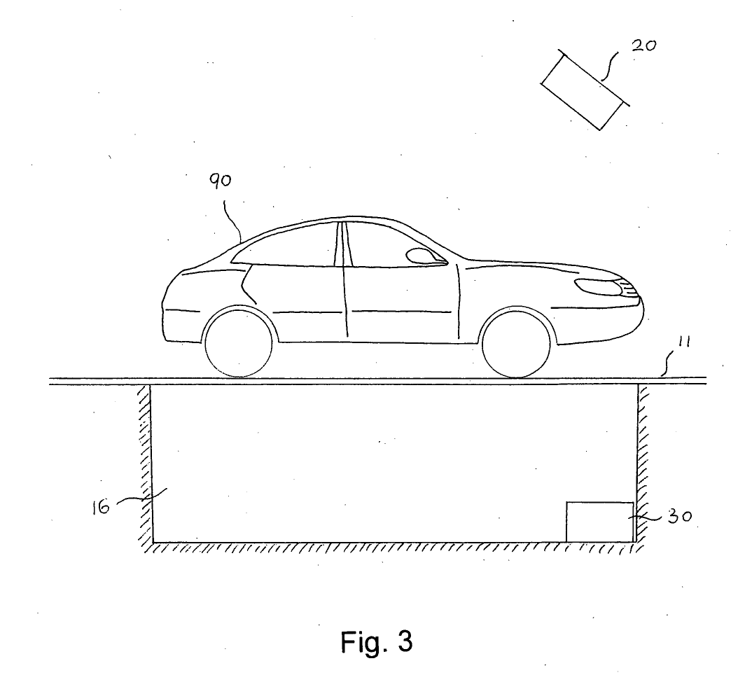

The step of performing a basic car maintenance S144 includes steps of coordinating in space and time with the step of post-washing S142, accessing the car, and maintaining the car S144. The step of coordinating in space and time with the step of post-washing S142 is performed by providing an extra accessing space for the maintenance work. The extra accessing space is provided by a pit 16 below the car 90 (refer to FIG. 3). The pit 16 is about 1 to 2 meters deep.

The basic car maintenance includes oil change process. The maintenance work is performed from under the car 90, and the post-washing work in step S130, S142 is performed from above the car 90. The maintenance work is coordinated to be performed in the opposite underside of the car 90 from the side where the post-washing work is performed. The basic car maintenance further includes car inspection and brake pad change.

A system 10 for car wash and maintenance includes a washing device 50 for cleaning the car, a drying device 20 for drying the car 90, and a maintaining device 30 comprising an accessing space for the maintenance work. The maintaining device 30 performs the maintenance works in the accessing space 16, 17 while the works of drying and touching-up are going on.

The accessing space includes a pit 16 below the car 90, and the pit 16 is adapted for the maintenance work to be performed.

The system 10 further includes an entrance 12 for introducing the car 90 into the system, a conveyor device 11 for moving the car 90 along the following steps, and a car-latching device 14 for fixing the car on the conveyor device 11.

The system 10 still further includes a waxing device 52 for coating the exterior surface of the car 90 with a protective thin film, a touching-up device 54, and an exit 18 for exiting the system 10.

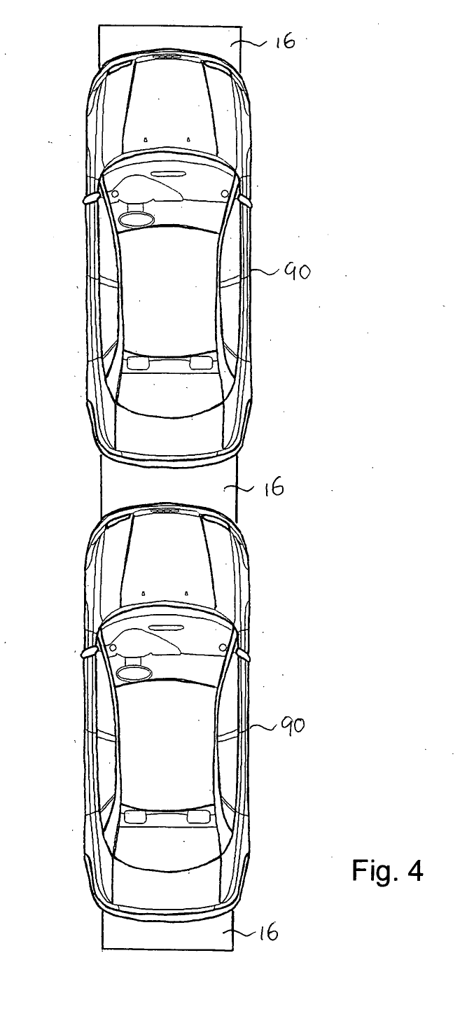

Two cars 90 are readied for a maintenance work over the pit 16 in FIG. 4. Also, a single car 90 can be readied over the pit 16 (not shown).

In other embodiment, the whole system 10 is a part of a larger system (not shown) which guide cars into different conveyor systems according to the services they choose; carwash only or maintenance work along with carwash.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. A method for car wash and maintenance comprising steps for:
a) car-washing;
b) post-washing for preparing the car for the driver's riding; and
c) performing a basic car maintenance,
wherein the step of performing a basic car maintenance is performed during the step of post-washing is going on.

2. The method of claim 1, further comprising a step of pre-washing for preparing the car for washing, wherein the step of pre-washing comprises steps for drive-in and latching the car.

3. The method of claim 1, wherein the step of car-washing comprises steps for pre-soaking, soaping-up, scrubbing, and rinsing.

4. The method of claim 1, wherein the step of post-washing comprises a step of drying.

5. The method of claim 1, wherein the step of post-washing further comprises steps of waxing and touching-up.

6. The method of claim 1, wherein the step of performing a basic car maintenance comprises steps of coordinating in space and time with the step of post-washing, accessing the car, and maintaining the car.

7. The method of claim 6, wherein the step of coordinating in space and time with the step of post-washing is performed by providing an extra accessing space for the maintenance work.

8. The method of claim 7, wherein the extra accessing space is provided by a pit below the car.

9. The method of claim 7, wherein the pit is about one (1) to two (2) meters deep.

10. The method of claim 6, wherein the basic car maintenance comprises oil change process.

11. The method of claim 10, wherein the maintenance work is performed from under the car, wherein the post-washing work is performed from above the car.

12. The method of claim 10, wherein the maintenance work is coordinated to be performed in the opposite underside of the car from the side where the post-washing work is performed.

13. The method of claim 6, wherein the basic car maintenance further comprises a car inspection and a brake pad change.

14. A system for car wash and maintenance comprising:
a) a washing device for cleaning the car;
b) a drying device for drying the car; and
c) a maintaining device comprising an accessing space for the maintenance work,
wherein the maintaining device performs the maintenance works in the accessing space while the works of drying and touching-up are going on.

15. The system of claim 14, wherein the accessing space comprises a pit below the car, wherein the pit is adapted for the maintenance work to be performed.

16. The system of claim 14, wherein the pit is about one (1) to two (2) meters deep.

17. The system of claim 16, wherein the predetermined height is from about one (1) meter to about two (2) meters.

18. The system of claim 14 further comprising:
a) an entrance for introducing a car into the system;
b) a conveyor device for proceeding the car along the following steps; and
c) a car-latching device for fixing the car on the conveyor device.

19. The system of claim 14, further comprising:
a) a waxing device for coating the car with a protective thin film;
b) a touching-up device; and
c) an exit for exiting the system.
